(19) United States
(12) Patent Application Publication
(10) Pub. No.: US 2023/0041035 A1
(43) Pub. Date: Feb. 9, 2023

(54) COMBINING MATH-PROGRAMMING AND REINFORCEMENT LEARNING FOR PROBLEMS WITH KNOWN TRANSITION DYNAMICS

(71) Applicant: INTERNATIONAL BUSINESS MACHINES CORPORATION, Armonk, NY (US)

(72) Inventors: Pavithra Harsha, Pleasantville, NY (US); Ashish Jagmohan, Irvington, NY (US); Brian Leo Quanz, Yorktown Heights, NY (US); Divya Singhvi, Yorktown Heights, NY (US)

(21) Appl. No.: 17/751,625

(22) Filed: May 23, 2022

Related U.S. Application Data
(60) Provisional application No. 63/229,049, filed on Aug. 3, 2021.

(51) Int. Cl. G06N 3/04; G06F 17/18

(52) U.S. Cl. CPC G06N 3/0472; G06F 17/18

(57) ABSTRACT

A computer implemented method of improving parameters of a critic approximator module includes receiving, by a mixed integer program (MIP) actor, (i) a current state and (ii) a predicted performance of an environment from the critic approximator module. The MIP actor solves a mixed integer mathematical problem based on the received current state and the predicted performance of the environment. The MIP actor selects an action a and applies the action to the environment based on the solved mixed integer mathematical problem. A long-term reward is determined and compared to the predicted performance of the environment by the critic approximator module. The parameters of the critic approximator module are iteratively updated based on an error between the determined long-term reward and the predicted performance.

### BACKGROUND

### Technical Field

The present disclosure generally relates to approximate dynamic programming (ADP), and more particularly, to systems and computerized methods of providing stochastic optimization.

### Description of the Related Art

Reinforcement learning (RL) is an area of machine learning that explores how intelligent agents are to take action in an environment to maximize a cumulative reward. RL involves goal-oriented algorithms, which learn how to achieve a complex objective (e.g., goal) or how to maximize along a particular dimension over many states.

In recent years, reinforcement learning (RL) has ushered in considerable break-throughs in diverse areas such as robotics, games, and many others. But the application of RL in complex real-world decision-making problems remains limited. Many problems in resource allocation of large-scale stochastic systems are characterized by large action spaces and stochastic system dynamics. These characteristics make these problems considerably harder to solve by computing platforms using existing RL methods that rely on enumeration techniques to solve per step action problems.

### SUMMARY

According to various exemplary embodiments, a computing device, a non-transitory computer readable storage medium, and a method are provided to carry out a method of improving parameters of a critic approximator module. A mixed integer program (MIP) actor receives (i) a current state and (ii) a predicted performance of an environment from the critic approximator module. The MIP actor solves a mixed integer mathematical problem based on the received current state and the predicted performance of the environment. The MIP actor selects an action a and applies the action to the environment based on the solved mixed integer mathematical problem. A long-term reward is determined and compared to the predicted performance of the environment by the critic approximator module. The parameters of the critic approximator module are iteratively updated based on an error between the determined long-term reward and the predicted performance. By virtue of knowing the structural dynamics of the environment and the structure of the critic, a problem involving one or more decisions can be expressed as a mixed integer program and efficiently solved on a computing platform.

In one embodiment, the mixed integer problem is a sequential decision problem.

In one embodiment, the environment is stochastic.

In one embodiment, the critic approximator module is configured to approximate a total reward starting at any given state.

In one embodiment, a neural network is used to approximate the value function of the next state.

In one embodiment, transition dynamics of the environment are determined by a content sampling of the environment by the MIP actor.

In one embodiment, upon completing a predetermined number of iterations between the MIP actor and the environment, an empirical returns module is invoked to calculate an empirical return, sometimes referred to herein as the estimated long-term reward.

In one embodiment, a computational complexity is reduced by using a Sample Average Approximation (SAA) and discretization of an uncertainty distribution.

In one embodiment, the environment is a distributed computing platform, and the action a relates to a distribution of a computational workload on the distributed computing platform.

According to one embodiment, a computing platform for making automatic decisions in a large-scale stochastic system having known transition dynamics includes a programming actor module that is a mixed integer problem (MIP) actor configured to find an action a that maximizes s a sum of an immediate reward and a critic estimate of a long-term reward of a next state traversed from a current state due to an action taken and a critic for an environment of the large-scale stochastic system. A critic approximator module coupled to the programming actor module that is configured to provide a value function of a next state of the environment. By virtue of this architecture, a Programmable Actor Reinforcement Learning (PARL) system is able to outperform both state-of-the-art machine learning as well as standard computing resource management heuristic

In one embodiment, the MIP actor uses quantile-sampling to find a best action a, given a current state of the large-scale stochastic system, and a current value approximation.

In one embodiment, the critic approximator module is a deep neural network (DNN).

In one embodiment, the critic approximator module is a rectified linear unit (RELUs) and is configured to learn a value function over a state-space of the environment.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 provides a conventional reinforcement learning framework between an actor, an environment, and a critic.

FIG. 2 is a conceptual block diagram of a programming actor reinforcement learning system, consistent with an illustrative embodiment.

FIG. 3 is an example Programmable Actor Reinforcement Learning algorithm, consistent with an illustrative embodiment.

FIG. 4 provides example formulas for the concepts discussed herein, consistent with an illustrative embodiment.

FIG. 5 provides block diagrams of multi-echelon supply chain structures, consistent with an illustrative embodiment.

FIG. 6 presents an illustrative process of an automatic and computationally efficient determination of a next action to take in a system having a complex environment, consistent with an illustrative embodiment.

FIG. 7 provides a functional block diagram illustration of a computer hardware platform that can be used to implement a particularly configured computing device that can host a Programmable Actor Reinforcement Learning (PARL) engine.

FIG. 8 depicts a cloud computing environment, consistent with an illustrative embodiment.

FIG. 9 depicts abstraction model layers, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure generally relates to systems and computerized methods of providing stochastic optimization. Reinforcement learning (RL) solves the challenge of correlating immediate actions with the delayed outcomes they produce. Like humans, RL algorithms sometimes may wait to determine the consequences of their decisions. They operate in a delayed-return environment, where it can be difficult to understand which action leads to which outcome over many time steps.

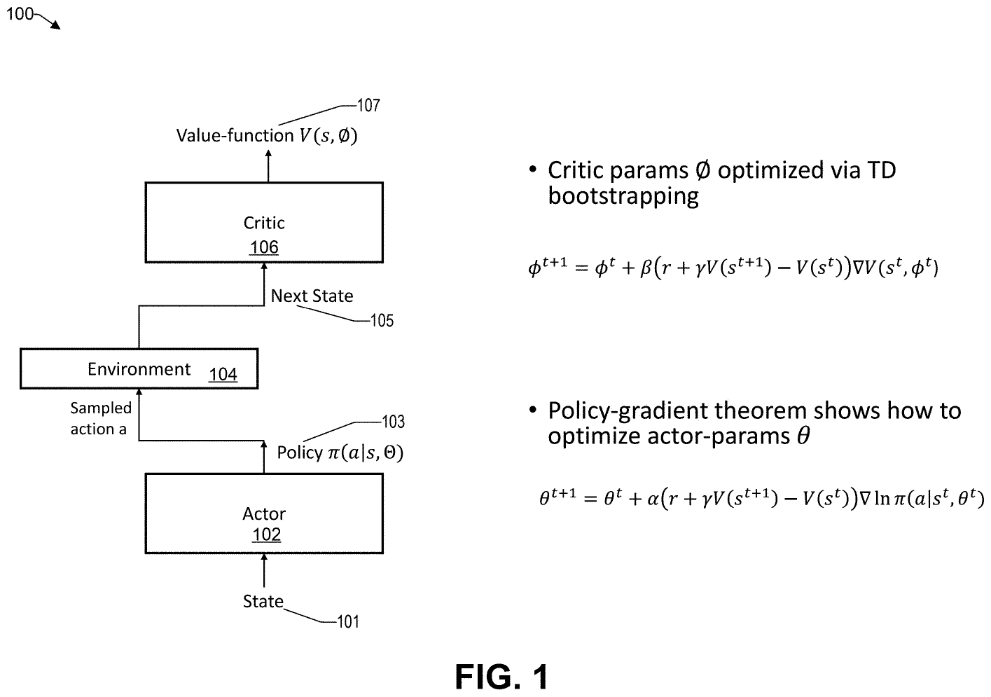

The concepts discussed herein may be better understood through the notions of environments, agents, states, actions, critics, and rewards. In this regard, reference is made to FIG. 1, which provides a conventional reinforcement learning framework between an actor 102, an environment 104, and a critic 106. As used herein, an agent, sometimes referred to herein as an actor 102, takes action, such as determining which course to take. The term “action” relates to a step selected by the agent from different possible steps. For example, an action may be to allocate a processing of a computational load to a particular computational node instead of another in a pool of computing resources.

As used herein, an “environment” 104 relates to the “world” the actor 102 can operate or traverse. The environment takes the actor's 102 current state and action as input, and returns as output the actor's reward and its next state 105. A critic 106 is operative to estimate the value function 107.

As used herein, a state 101 relates to a concrete situation in which the actor finds itself (e.g., time and place). A policy 103 is the strategy that the actor 102 employs to determine the next action based on the current state 101. A policy maps states to actions, for example, the actions that promise the highest reward.

As used herein, a value function (V) 107 relates to an expected long-term return, as opposed to a short-term reward. For example, the value function 107 is the expected long-term return of the current state under the policy 103. A reward is an immediate signal that is received in a given state, whereas a value function 107 is the sum of all rewards from a state, sometimes referred to herein as an empirical return. For example, value is a long-term expectation, while a reward is a more immediate response. As used herein, the term “trajectory” relates to a sequence of states and actions that influence those states.

The function of the environment 104 may not be known. For example, it can be regarded a black box where only the inputs and outputs can be seen. By virtue of using RL, the actor 102 can attempt to approximate the environment's function, such that actions can be sent into the “black-box” environment that maximize the rewards it generates. RL can characterize actions based on the results they produce. It can learn sequences of actions, sometimes referred to herein as trajectories, that can lead an actor to, for example, maximize its objective function.

As used herein, mathematical programming (MP), sometimes referred to mathematical optimization, is a selection of a best element with respect to one or more criteria, from a set of available alternatives. Linear programming (LP) and mixed-integer programming (MIP) are special cases of MP.

The teachings herein facilitate computerized decision making in large scale systems. Decision making is often an optimization problem, where a goal is to be achieved and/or objective function optimized (e.g., maximized or minimized). Often, a single decision is not enough; rather, a sequence of decisions is often involved. The decisions that are made at one state may ultimately affect subsequent states. These types of problems are often referred to as sequential decision problems. Further, systems that are being operated on may be stochastic in that various parameters affecting the system may not be deterministic. For example, the amount of memory required to be processed by a computing platform may vary from one application to another or from one day to another. Due to the stochastic nature of a system, the optimization of decisions becomes a computational challenge. So, the question becomes, how to adjust the decision policies to maximize one or more expected key performance indicators (KPIs) of a system? Solving such problems for a large stochastic system is often computationally not feasible, may not converge, or require too many computational resources.

Known approaches to solving this computational challenge relate to making simplifying assumptions by, for example, replacing the stochastic random variables with a value, an average value, sample approximation averaging, etc., each having limited precision or success. Reinforcement learning or deep reinforcement learning are additional approaches, which essentially regard the environment as a black box and learns from actions performed by an agent (e.g., actor 101). These known approaches may work in some settings (e.g., simple settings), but not in others, such as more complicated systems having many elements and/or involving large data. If there is a highly stochastic system (e.g., probability distribution having a large variance), these stochastic optimization techniques break down and a computing device may not be able to provide a meaningful result. For example, the calculations may take too long on a computing platform or simply not come to convergence.

The teachings herein provide a unique hybrid approach that combine aspects of the reinforcement learning techniques with stochastic optimization. To better understand the teachings herein it may be helpful to contrast it to typical actor critic algorithms by way of the architecture 100 of FIG. 1. In the example of FIG. 1, both the actor 102 and the critic 106 are approximators, such as neural nets. The environment is a “black box” that is acted upon. Given the current state 101 of the system 100, the actor 102 tries to learn a policy 103. For example, the policy 103 is simply the probability distribution of actions given the current state 101. The environment 104 changes its state 105 in response to the action. Next, the critic module 106 determines the quality (i.e., value) of the next state. A technical challenge with the architecture 100 of FIG. 1 is that it may require substantial computational resources or may not even converge within a reasonable time period.

In contrast to the architecture 100 of FIG. 1, the teachings herein do not use a traditional actor. Instead, there is a program (e.g., MIP) actor module that is cognizant of the transition dynamics of the environment. Stated differently, instead of randomly exploring different policies by the actor, the MIP-actor discussed herein is able to provide more focused actions that more quickly provide the desired results (e.g., empirical return of the environment). The fact that the problem structure, such as the reward parameters, constraints, and system dynamics to be solved, are known (e.g., intelligently predicted by the critic) is leveraged to reduce uncertainty of the underlying reward, thereby providing the technical benefit of substantially reducing the computational resources in the exploration involved. Instead of trying to discover “good” sequences of actions via iterative sampling, the programming actor module leverages knowledge of the problem structure, and a critic approximator, to directly solve for good actions. The state-space (e.g., environment) is explored much more efficiently since the programming actor can compute the exact actions that will lead to “good” states per current program critic. The teachings herein facilitate a better scaling to larger problems (e.g., distribution of a computational workload on a computing platform, larger supply-chain networks, etc.,) and yields much faster (sample-efficient) convergence on a given computing platform.

In one aspect, the teachings herein provide a Programmable Actor Reinforcement Learning (PARL), a policy iteration method that uses techniques from integer programming and sample average approximation. For a given critic, the learned policy in each iteration converges to an optimal policy as the underlying samples of the uncertainty go to infinity. Practically, a properly selected discretization of the underlying uncertainty distribution can yield a more near optimal actor policy even with very few samples from the underlying uncertainty.

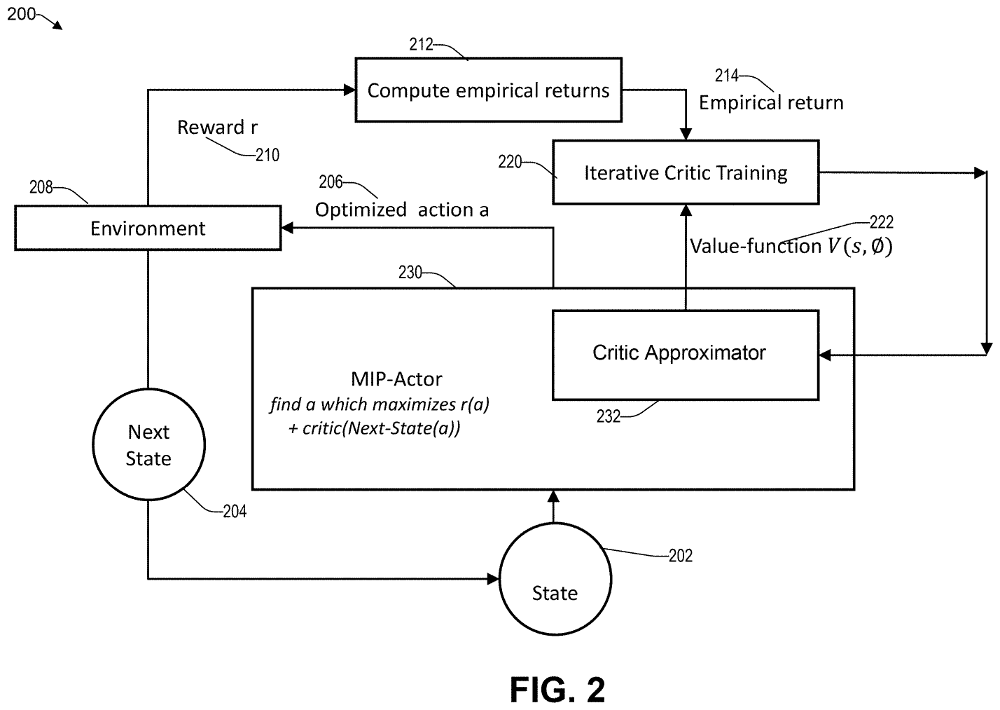

Reference now is made to FIG. 2, which is a conceptual block diagram of a programming actor reinforcement learning (PARL) system 200, consistent with an illustrative embodiment. The PARL system 200 includes a program (e.g., a mixed integer program (MIP)) actor module 230. The programming actor module 230 includes a critic approximator module 232, that approximates the total rewards starting at any given state, sometimes referred to herein as an empirical return 214.

The programming actor 230, given a current state 202, solves a mixed integer program to find a good action to take by way of solving a mixed integer mathematical problem instead of the iterative trial and error approach. The programming actor 230 is able to find the option that maximizes the reward over the entire trajectory by decomposing it into immediate reward and the reward from the next state. The reason that the programming actor 230 is aware what the immediate reward would be for a given action—is that it is aware of the dynamics of the environment 208. Further, the programming actor 230 includes a critic approximator module 232 that acts as a function approximator operative to provide a value function of the next state. By virtue of knowing the structural dynamics of the environment 208 and the structure of the critic 232, the problem can be expressed as a mixed integer program and efficiently solved on a computing platform. In one embodiment, the transition dynamics of the environment 208 are determined by content sampling, such as sample average approximation (SAA) of the environment 208. Transition dynamics relate to how one would transition from one state to another depending on the action taken. If the system has some random behavior, these transition dynamics are characterized by a probability distribution. For example, the programming actor module 230 determines an action to take by solving a mixed integer problem (MIP), to come up with a more optimized action 206 to be applied to the given environment 208. The environment responds with a reward 210 and the next state. At block 212, the empirical returns (i.e., the actual returns from the environment) are determined and applied to block 220, where iterative critic training is applied. In each iteration, depending on the state of the system, the corresponding optimized action a 206 is applied to the environment 208 until a threshold criterion is achieved (e.g., a trajectory of n steps). Thus, n is the length of the trajectory. Many more simulations can be performed. A collection of these trajectories, the critic can be retrained, and new trajectories of length n applied with the new critic. Two main features can be identified, namely (i) what the actual final reward is for the trajectory (i.e., empirical return 214), and (ii) how well the critic 232 performed in predicting this reward or sequence of rewards, collectively referred to herein as a total reward. Stated differently, based on an error between the identified actual reward and the predicted reward from the critic 232, the parameters of the critic approximator 232 can be adjusted. For example, the set of parameters that minimize this error can be selected. In this way, the critic approximator module 232 can be iteratively finetuned. In each iteration of using the critic 232, the critic can improve and provide a better prediction of the empirical reward 214 for a given environment 208.

Accordingly, the better the critic 232 is in predicting the long-term reward for a trajectory, the more accurately and quickly the programming actor 230 can determine what action to take, thereby substantially reducing exploration required and thus improving the sample efficiency and/or the computational requirements of a computing platform. Thus, solving this mixed integer problem for a given state 202 and the input from the critic 232 is able to provide a “good” action to be applied to the environment 208 to maximize a final reward. As the critic 232 improves over time, so does the programming actor 230 in determining an action to take. The system 200 determines a sequence of empirical rewards to determine an empirical return 214 based on a trajectory. Additional trajectories may be evaluated in a similar way.

For example, consider a trajectory having 1000 steps. In this regard, the programming actor 230 is invoked 1000 times. More specifically the critic 232 and the environment 208 are invoked 1000 times. Upon completing the 1000 iterations, the compute empirical returns module 212 is invoked, which calculates an empirical return 214, sometimes referred to herein as a value function. The error between the predicted empirical return (by the critic approximator 232) and the actual empirical return 214 facilitates the iterative critic training 220 of the critic approximator 232. Upon completion (and possible improvement of the critic 232) a new trajectory can be evaluated. Hundreds or thousands of such trajectories can be efficiently evaluated on a computing platform.

In one embodiment, the teachings herein apply neural networks to approximate the value function as well as aspects of Mathematical Programming (MP) and Sample Average Approximation (SAA) to solve a per-step-action optimally. For example, the value-to-go is the quantity that the value-function 222 is approximating. A per-step-action is an action taken per round 206. The framework of system 200 can be applied in various domains, including, without limitation, computing resource allocation and to solve real world inventory management problems having complexities that make analytical solutions intractable (e.g., lost sales, dual sourcing with lead times, multi-echelon supply chains, and many others).

The system 200 involves a policy iteration algorithm for dynamic programming problems with large action spaces and underlying stochastic dynamics, referred to herein as Programmable Actor Reinforcement Learning (PARL). In one embodiment, the architecture uses a neural network to approximate the value function 222 along with the SAA techniques discussed herein. In each iteration, the approximated NN is used to generate a programming actor 230 policy using integer-programming techniques.

In one embodiment, to resolve the issue of computational complexity and underlying stochastic dynamics, SAA and discretization of an uncertainty distribution are used. For a given critic 232 of the programming actor 230, the learned policy in each iteration converges to the optimal policy as the underlying samples of the uncertainty go to infinity. If the underlying distribution of the uncertainty is known, a properly selected discretization can yield near optimal programming actor 230 policy even with very few samples. As used herein, a policy is a function that defines an action for every state.

By virtue of the teachings herein, the PARL system 200 is able to outperform both state-of-the-art machine learning as well as standard computing resource management heuristic.

### Example Mathematical Explanation

Consider an infinite horizon discrete-time discounted Markov decision process (MDP) with the following representation: states s ∈ S, actions a ∈ [symbol] (s), uncertain random variable D ∈ [symbol] ^{dim} with probability distribution P(D=d|s) that depends on the context state s, reward function R(s, a, D), distribution over initial states β, discount factor γ and transition dynamics s′=T(s, a, d) where s′ represents the next state. A stationary policy π ∈ Π is specified as a distribution π(.|s) over actions A(s) taken at state s. Then, the expected return of a policy π ∈ Π is given by J^{π}=E_{s˜β}V^{π}(s), where the value function is defined as V^{π}(s)=Σₜ₌₀^{∞} [symbol] [γ^{t}R(sₜ, aₜ, Dₜ)|s₀=s, π, P, T]. The optimal policy is given by π*:=arg max_{π∈Π}J^{π}. The Bellman's operator F[V](s)=max_{a∈A(s)} [symbol] _{D˜P(./s,a)}[R(s, a, D)+γV(T(s, a, D))] over the state space has a unique fixed pint (i.e., V=FV) at V^{π}. This is salient in the policy iteration approach used herein, which improves the learned value function, and hence, the policy over subsequent iterations.

In one embodiment, the state space S is bounded, the action space A(s) comprises discrete and/or continuous actions in a bounded polyhedron, and the transition dynamics T(s, a, d) and the reward function R(s, a, D) are piece-wise linear and continuous in a ϵ A(s).

In one embodiment, a Monte-Carlo simulation-based policy-iteration framework is used, where the learned policy is the outcome of a mathematical program, referred to herein as PARL. PARL is initialized with a random policy. The initial policy is iteratively improved over epochs with a learned critic (or the value function). In epoch j, policy πⱼ₋₁ is used to generate N sample paths, each of length T. At every time step, a tuple of {state, reward, next-state} is also generated, which is then used to estimate the value function \hat{V}_{θ}^{π}^{_{j−1}} using a neural network parametrized by θ. Particularly, in every epoch, for each sample path, an estimate of the cumulative reward is calculated by the following expression:

Yₙ(s₀ⁿ)=Σₜ₌₁^{T}γ^{t-1}Rᵢₜ, ∀n=1, . . . , N, (Eq. 1)

Where s₀ⁿ is the initial state of sample-path n.

In one embodiment, to increase the buffer size, partial sample paths can be used. The initial states and cumulative rewards can be then passed on to a neural network, which estimates the value of policy πⱼ₋₁ for any state, i.e., \hat{V}_{θ}ⁿ^{_{j−1}}. Once a value estimate is generated, the new policy using the trained critic is provided by the expression below:

$${π}_{j} ( s ) = arg {max}_{a ∈ A ( s )} {𝔼}_{D} [ R ( s , a , D ) + γ {\hat{V}}_{θ}^{{π}_{j - 1}} ( T ( s , a , D ) ) ] \qquad ( Eq . 2 )$$

The problem presented by equation 2 above is difficult to solve by a computing platform for two main reasons. First, notice that \hat{V}^{π}^{_{j−1}} is a neural network that makes enumeration-based techniques intractable, especially for settings where the actions space is large. Second, the objective function involves evaluating expectation over the distribution of uncertainty D that is analytically intractable to compute on a computing platform.

Consider the problem of equation 2 above for a single realization of uncertainty D given by the expression below:

max_{a∈A(s)}R(s, a, d)+γ\hat{V}_{θ}^{π}^{_{j−1}}(T(s, a, d)) (Eq. 3)

A mathematical programming (MP) approach can be used to solve the problem presented by equation 3 above. It can be assumed that the value V function is a trained K layer feed forward RELU network that with input state s satisfies the following equations:

z₁=s, \hat{z}ₖ=Wₖ₋₁zₖ₋₁+bₖ₋₁,

zₖ=max{0, \hat{z}ₖ}, ∀k=2, . . . , K, \hat{V}_{θ}(s):=c^{T}\hat{z}_{K} (Eq. 4)

Where:

θ=(c, {(Wₖ, bₖ)}ₖ₌₁^{K-1}) are the weights of the V network;

(wₖ, bₖ) being the multiplicative and bias weights of layer k;

c being the weights of the output layer; and

\hat{z}ₖ, zₖ denote the pre and post activation values at layer k.

The non-linear equations re-written exactly as an 1VIP with binary variables and M constraints. Starting with the bounded input to the V network, which can be derived from the bounded nature of S, the upper and lower bounds for subsequent layers can be obtained by assembling the max {0, M⁺} and {0, M⁻} for each neuron from its prior layer. They can be referred as [lₖ, uₖ] for every layer k. This reformulation of the V network combined with linear nature of the reward function R(s, a, d) with regard to a and polyhedral description of the feasible set A(s), lend themselves in reformulating the problem of equation 2 as an MP for any given realization of d.

Example Maximization of Expected Reward with a Large Action Space:

The problem expressed in the context of equation 2 above maximizes the expected parameter (e.g., efficient utilization of memory, profit, etc.,) where the expectation is taken over an uncertainty set D. Evaluating the expected value of the approximate reward is computationally cumbersome on a given computing platform. Accordingly, in one embodiment, a Sample Average Approximation (SAA) approach is used to solve the problem in equation 2. Let d₁, d₂, . . . d_{η} denote η independent realizations for the uncertainty D.

In one embodiment, the following expression is used:

$${\hat{π}}_{j}^{η} ( s ) = arg {max}_{a ∈ A ( s )} \frac{1}{η} {\sum }_{i = 1}^{η} R ( s , a , {d}_{i} ) + γ {\hat{V}}_{θ}^{{π}_{j - 1}^{η}} ( T ( s , a , {d}_{i} ) ) \qquad ( Eq . 5 )$$

The problem expressed in equation 5 above involves evaluating the objective only at sampled demand realizations. Assuming that for any η, the set of optimal actions is non-empty, as the number of samples η grows, the estimated optimal action converges to the optimal action.

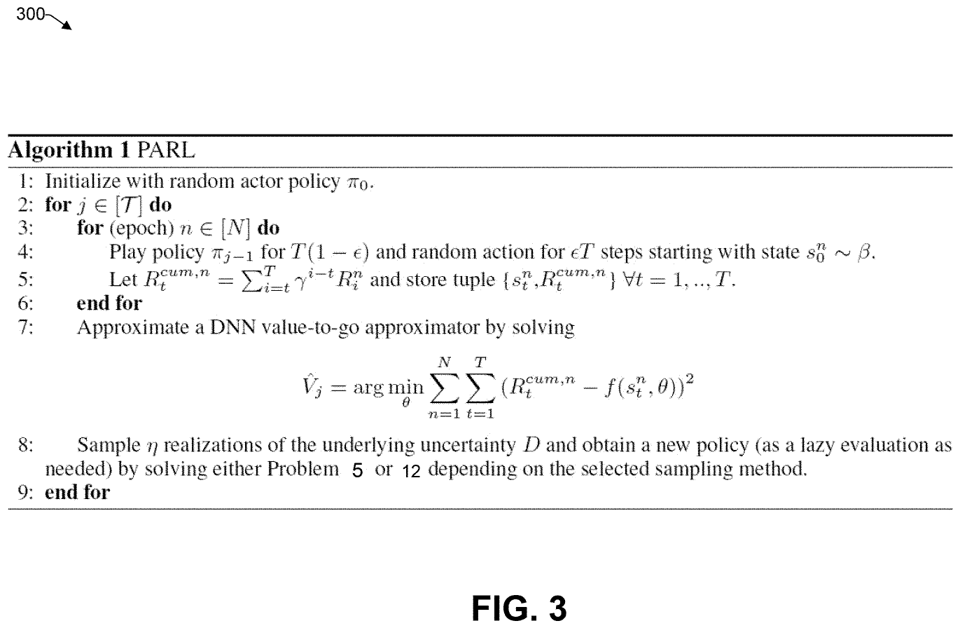

Reference now is made to FIG. 3, which is an example PARL algorithm, consistent with an illustrative embodiment. Consider epoch j of the PARL algorithm 300 with a RELU network value estimate \hat{V}_{θ}^{π}^{_{j−1}}(s) for some fixed policy πⱼ₋₁. Suppose πⱼ, \hat{π}ⱼ^{η} are the optimal policies as described in the problem of equation 2 and its corresponding SAA approximation, respectively, Then ∀ s,

$${lim}_{η \to ∞} {\hat{π}}_{j}^{η} ( s ) = {π}_{j} ( s ) \qquad ( Eq . 6 )$$

Accordingly, the quality of the estimated policy improves as the number of demand samples increase. Nevertheless, the computational complexity of the problem also increases linearly with the number of samples: for each demand sample, the DNN based value estimation is represented using binary variables and the corresponding set of constraints.

In one embodiment, a weighted scheme is used when the uncertainty distribution P(D=d|s) is known and independent across different dimensions. Let q₁, q₂, . . . q_{η} denote η quantiles (e.g., evenly split between 0 to 1). Also, let the following expression denote the cumulative distribution function and the probability density function of the uncertainty D in each dimension, respectively.

Fⱼ & fⱼ, ∀j=1, 2 . . . , dim (Eq. 7)

Let the following expression denote the uncertainty samples and their corresponding probability weights.

dᵢⱼ=Fᵢ⁻¹(qᵢ) & wᵢⱼ=fⱼ(qᵢ), ∀i=1, 2, . . . , η, j=1, 2 . . . dim (Eq. 8)

Then, a single realization of the uncertainty is a dim dimensional vector di=[dᵢ₁, . . , d_{i,dim}] with associated probability weight provided by the expression below:

wᵢ^{pool}=wᵢ₁*wᵢ₂ . . . *w_{i,dim} (Eq. 9)

With η realizations of uncertainty in each dimension, in total there are η^{dim} such samples. The following expression provides the set of demand realizations sub sampled from this set along with the weights (based on maximum weight or other rules) such that |Q|=η.

Q={dᵢ, wᵢ^{pool}} (Eq. 10)

w_{Q}=Σ_{i∈Q}wᵢ^{pool} (Eq. 11)

Then, the problem expressed in equation 5 becomes the following:

$${\hat{π}}_{j}^{η} ( s ) = arg {max}_{a ∈ A ( s )} {\sum }_{d ∈ 𝒬} {w}_{i} ( R ( s , a , {d}_{i} ) + γ {\hat{V}}_{θ}^{{π}_{j - 1}^{η}} ( T ( s , a , {d}_{i} ) ) ) \qquad ( Eq . 12 )$$

$$Where {w}_{i} = {w}_{i}^{pool} / {w}_{𝒬}$$

The computational complexity of solving the above problem depicted in the context of equation 12 remains the same as before, but since weighted samples are used, the approximation to the underlying expectation improves further.

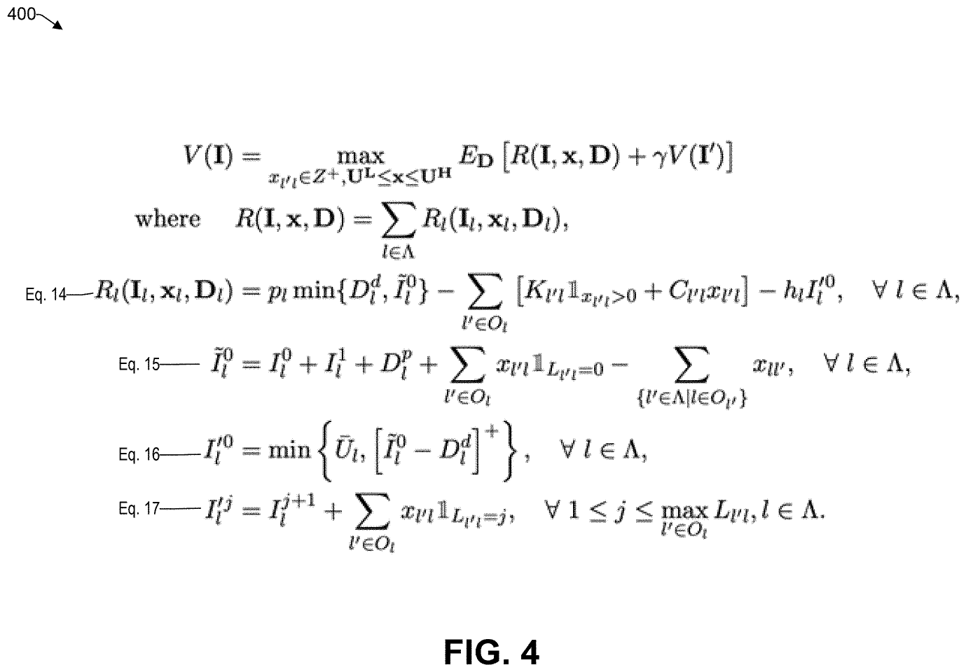

FIG. 4 provide example formulas for the concepts discussed herein, consistent with an illustrative embodiment, for the case of the multi-echelon supply chain. By way of example only and not by way of limitation, an application of PARL is described below in the context of a multi-echelon inventory management, while it will be understood that the concepts can be applied in other domains, such as allocation of computing resources on a computing platform, such as a cloud.

Consider an entity managing inventory replenishment and distribution decisions for a single product across a network of nodes with a goal to maximize efficient allocation of resources while meeting customer demands. Let A be the set of nodes, indexed by l. Each of the nodes can produce a stochastic amount of inventory in every period denoted by the random variable (r.v) Dₗ^{p}, which is either kept or distributed to other nodes. Any such distribution from node l to l′ has a deterministic lead time L_{ll′}≥0 and is associated with a fixed cost K_{ll′} and a variable cost C_{ll′}. Every node uses the inventory on-hand to fulfill local stochastic demand denoted by the r.v. Dₗ^{d} at a price pl. We assume any excess demand is lost. If there is an external supplier, we denote it by a dummy node S^{E}. For simplicity, we assume there is at most one external supplier and that the fill rate from that external supplier is 100% (i.e., everything that is ordered is supplied). We denote the upstream nodes that supply node l by the set Oₗ ⊂ A ∪ S^{E}. In every period, the entity decides what inventory to distribute from one node to another and what inventory each node should request from an external supplier. All replenishment decisions have lower and upper capacity constraints denoted by the equation below:

U_{ll′}^{L} and U_{ll′}^{H} (Eq. 13)

There is also holding capacity at every node denoted by Ūₗ. The entity's objective is to maximize the overall efficiency of the allocation. Assuming an i.i.d nature of stochasticity, for each r.v, the entity's problem can be modeled as an infinite horizon discrete-time MDP as provided by the expressions 400 in FIG. 4

In the example of FIG. 4, the inventory pipeline vector for all nodes and the state space of the MDP, xl the action taken by the entity described by the vector of inventory movements from all other nodes to node l at time t, Rl(⋅) the reward function for each node l described in equation 14, I′ the next state defined by the transition dynamics in equations 16 and 17 and auxiliary variables Ĩₗ⁰ defined in equation 15 (of FIG. 4). The auxiliary variable has an interpretation of the total inventory in the system prior to meeting demand, which stems from the on-hand inventory Iₗ⁰, incoming pipeline Iₗ¹, stochastic node production Dₗ^{p}, the incoming inventory from other nodes with lead time zero and the out-going inventory from this node.

In one embodiment, the state space I is a collapsed state space compared to the inventory pipelines over connections between nodes as the reward R_{tl(⋅)} just depends on collapsed node inventory pipelines. Also, transportation cost and holding cost related to pipeline inventory are without loss of generality set to 0, as the variable purchase cost C_{ll′} can be modified according to account for these additional costs.

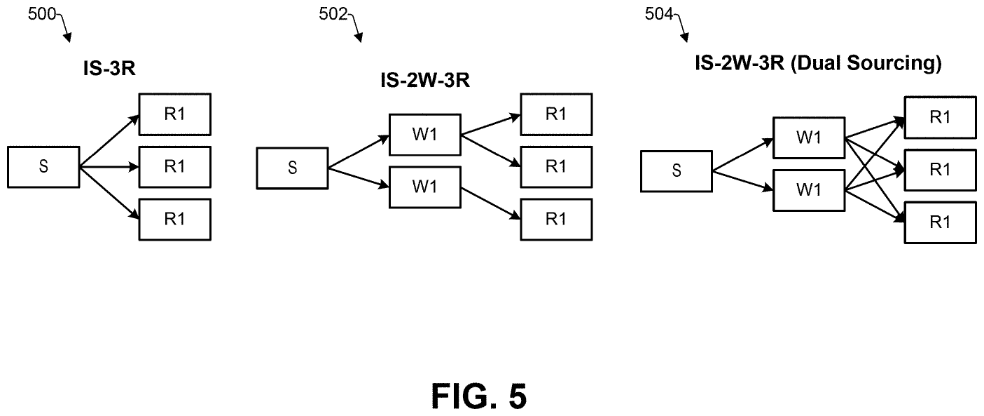

The architecture encompassed by the equations of FIG. 4 can model many real-world multi-echelon resource allocation systems, such as computing resources or supply chains. In this regard, FIG. 5 provides block diagrams of multi-echelon supply chain structures, consistent with an illustrative embodiment. FIG. 5 shows three types of nodes, namely supply nodes (S), which are configured to produce inventory for downstream, warehouse nodes (W), which are configured to act as distributors, and retail nodes (R), which face external demand. The supply node can be part of A or be an external supplier S^{E}. In example 500 (i.e., 1S-3R), a single supplier node serves a set of three retail nodes directly. In example 502 (i.e., 1S-2W-3R, the supplier node serves the retail nodes through two warehouses. In example 504 (i.e., 1S-2W-3R—dual sourcing), each retail node is served by two distributors. Example 504 depicts how nodes can have two inventory sources, commonly referred to as a dual-source setting.

### Example Process

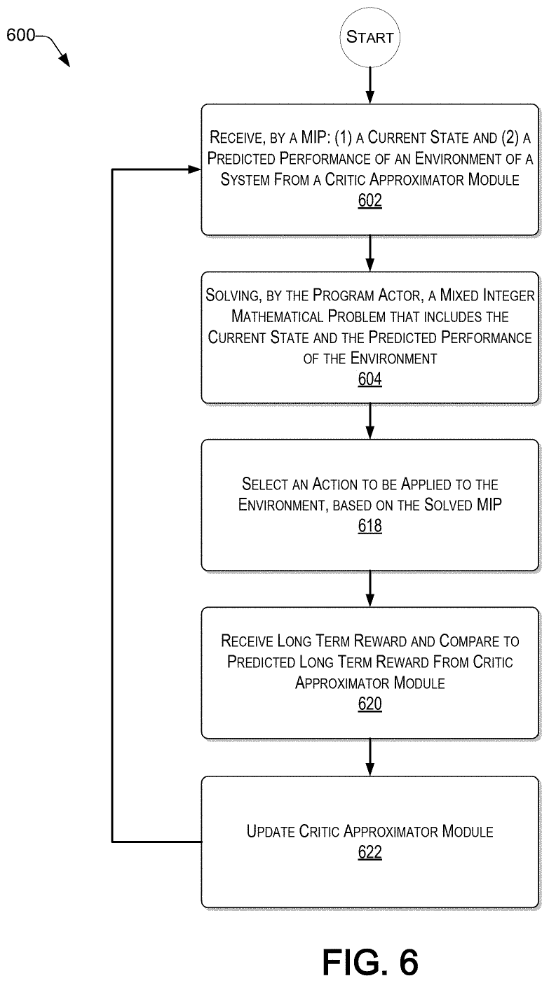

With the foregoing overview of the example architecture 200 of a PARL system, it may be helpful now to consider a high-level discussion of an example process. To that end, FIG. 6 presents an illustrative process 600 of an automatic and computationally efficient determination of a next action to take in a system having a complex environment. Process 600 is illustrated as a collection of blocks in a logical flowchart, which represents sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described blocks can be combined in any order and/or performed in parallel to implement the process. For discussion purposes, the process 600 is described with reference to the architecture 200 of FIG. 2.

With reference to FIG. 2, a PARL system 200 may include various modules such as a mixed integer program actor module 230 having a critic approximator 232, iterative critic training module 220, environment 208 determination module, and others, as discussed hereinabove to provide stochastic optimization that not only provides a more accurate result but also conserves the computing resources of the computing platform.

At block 602, the programming actor 230 of the computing device receives (i) a current state 202 and (ii) a predicted performance of the environment 208 of a system from a critic approximator module 232.

At block 604, the programming actor 604, solves a mixed integer mathematical problem (MIP) based on the received current state 202 and the predicted performance of the environment 208 from the critic approximator module 232.

At block 618, an action a to be applied to the environment 208 is applied by the programming actor 230 based on the solved MIP.

At block 620, the long-term reward, sometimes referred to herein as the empirical return 214, is determined and compared to that predicted by the critic approximator module 232. At block 622, the critic approximator module 232 is updated based on the determined error. In this way, the critic approximator module 232 is constantly improved in every iteration.

### Example Computer Platform

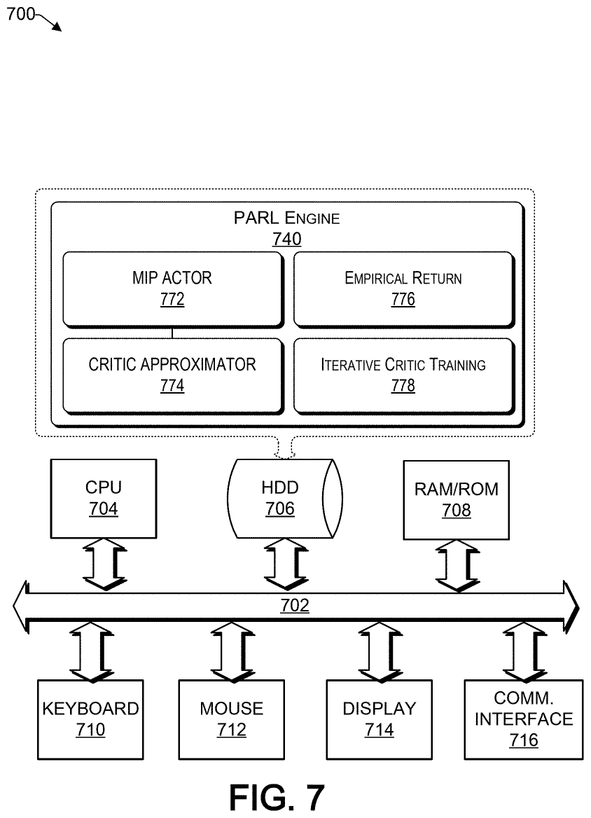

As discussed above, functions relating to controlling actions of a complex system can be performed with the use of one or more computing devices connected for data communication via wireless or wired communication in accordance with the architecture 200 of FIG. 2. FIG. 7 provides a functional block diagram illustration of a computer hardware platform 700 that can be used to implement a particularly configured computing device that can host a PARL engine 740. In particular, FIG. 7 illustrates a network or host computer platform 700, as may be used to implement an appropriately configured server.

The computer platform 700 may include a central processing unit (CPU) 704, a hard disk drive (HDD) 706, random access memory (RAM) and/or read only memory (ROM) 708, a keyboard 710, a mouse 712, a display 714, and a communication interface 716, which are connected to a system bus 702.

In one embodiment, the HDD 706, has capabilities that include storing a program that can execute various processes, such as the PARL engine 740, in a manner described herein. The PARL engine 740 may have various modules configured to perform different functions, such those discussed in the context of FIG. 1 and others. For example, the PARL engine 740 may include an MIP actor module 772 that is operative to determine a next action to take with respect to a stochastic environment. There may be a critic approximator module 774 that is operative to predict a performance of the stochastic environment, such that it can provide guidance to the MIP actor. There may be an empirical return module 776 operative to determine an empirical return of a trajectory, as discussed herein. There may be a critic training module 778 that compares a predicted empirical return provided by the critic approximator 774 to the actual empirical return and adjusts the critic approximator 774 based on the determined error.

While modules 772 to 778 are illustrated in FIG. 7 to be part of the HDD 706, in some embodiments, one or more of these modules may be implemented in the hardware of the computing device 700. For example, the modules discussed herein may be implemented in the form of partial hardware and partial software. That is, one or more of the components of the PARL engine 740 shown in FIG. 7 may be implemented in the form of electronic circuits with transistor(s), diode(s), capacitor(s), resistor(s), inductor(s), varactor(s) and/or memristor(s). In other words, the PARL engine 740 may be implemented with one or more specially-designed electronic circuits performing specific tasks and functions described herein.

### Example Cloud Platform

As discussed above, functions relating to determining a next action to take or processing a computational load, may include a cloud. It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

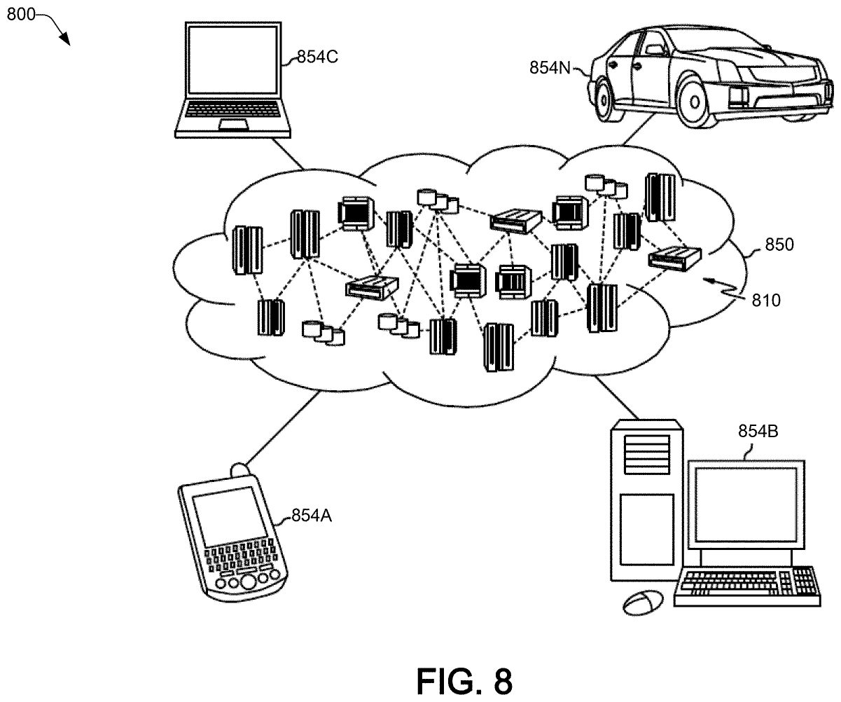

Referring now to FIG. 8, an illustrative cloud computing environment 800 is depicted. As shown, cloud computing environment 800 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

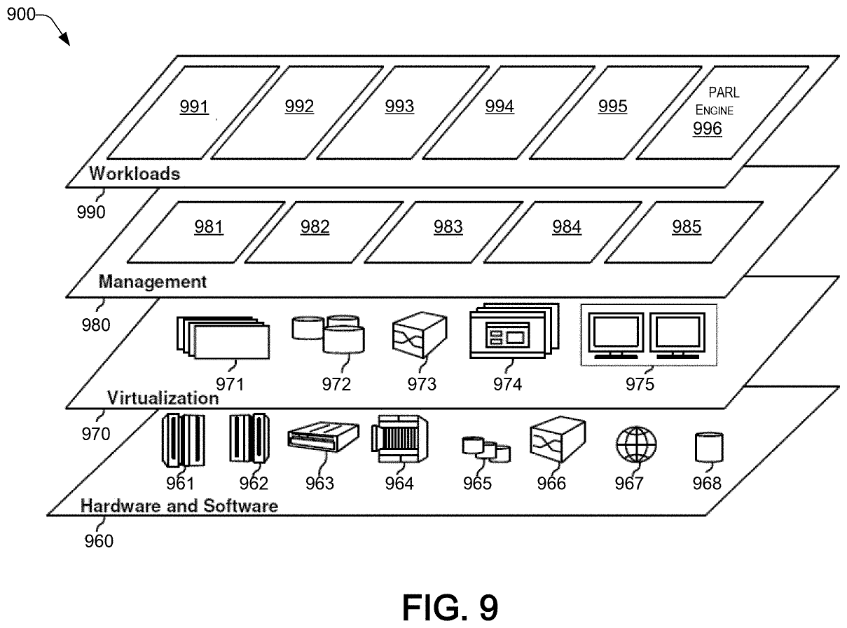

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 960 includes hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and PARL engine 996, as discussed herein.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a storage device coupled to the processor;
a Programmable Actor Reinforcement Learning (PARL) engine stored in the storage device, wherein an execution of the PARL engine by the processor configures the processor to perform acts comprising:
receiving, by a mixed integer program (MIP) actor, (i) a current state and (ii) a predicted performance of an environment from a critic approximator module;
solving, by the MIP actor, a mixed integer mathematical problem based on the received current state and the predicted performance of the environment;
selecting, by the MIP actor, an action a and applying the action to the environment based on the solved mixed integer mathematical problem;
determining a long-term reward and comparing the long-term reward to the predicted performance of the environment by the critic approximator module; and
iteratively updating parameters of the critic approximator module based on an error between the determined long-term reward and the predicted performance.

2. The computing device of claim 1, wherein the mixed integer problem is a sequential decision problem.

3. The computing device of claim 1, wherein the environment is stochastic.

4. The computing device of claim 1, wherein the critic approximator module is configured to approximate a total reward starting at any given state.

5. The computing device of claim 4, wherein a neural network is used to approximate the value function of the next state.

6. The computing device of claim 1, wherein transition dynamics of the environment are determined by a content sampling of the environment by the MIP actor.

7. The computing device of claim 1, wherein an execution of the engine further configures the processor to perform an additional act comprising, upon completing a predetermined number of iterations between the MIP actor and the environment, invoking an empirical returns module to calculate an empirical return.

8. The computing device of claim 1, wherein an execution of the engine further configures the processor to perform additional acts comprising reducing a computational complexity by using a Sample Average Approximation (SAA) and discretization of an uncertainty distribution.

9. The computing device of claim 1, wherein:
the environment is a distributed computing platform; and
the action α relates to a distribution of a computational workload on the distributed computing platform.

10. A non-transitory computer readable storage medium tangibly embodying a computer readable program code having computer readable instructions that, when executed, causes a computing device to carry out a method of improving parameters of a critic approximator module, the method comprising:
receiving, by a mixed integer program (MIP) actor, (i) a current state and (ii) a predicted performance of an environment from the critic approximator module;
solving, by the MIP actor, a mixed integer mathematical problem based on the received current state and the predicted performance of the environment;
selecting, by the MIP actor, an action a and applying the action to the environment based on the solved mixed integer mathematical problem;
determining a long-term reward and comparing the long-term reward to the predicted performance of the environment by the critic approximator module; and
iteratively updating parameters of the critic approximator module based on an error between the determined long-term reward and the predicted performance.

11. The non-transitory computer readable storage medium of claim 10, wherein the mixed integer problem is a sequential problem.

12. The non-transitory computer readable storage medium of claim 10, wherein the environment is stochastic.

13. The non-transitory computer readable storage medium of claim 10, wherein the critic approximator module is configured to approximate a total reward starting at any given state

14. The non-transitory computer readable storage medium of claim 13, wherein a neural network is used to approximate the value function of the next state.

15. The non-transitory computer readable storage medium of claim 10, further comprising reducing a computational complexity by using a Sample Average Approximation (SAA) and discretization of an uncertainty distribution.

16. The non-transitory computer readable storage medium of claim 10, wherein:
the environment is a distributed computing platform; and
the action α relates to a distribution of a computational workload on the distributed computing platform.

17. A computing platform for making automatic decisions in a large-scale stochastic system having known transition dynamics, comprising:
a programming actor module that is a mixed integer problem (MIP) actor configured to find an action α that maximizes a sum of an immediate reward and a critic estimate of a long-term reward of a next state traversed from a current state due to an action taken and a critic for an environment of the large-scale stochastic system; and
a critic approximator module coupled to the programming actor module that is configured to provide a value function of a next state of the environment.

18. The computing platform of claim 17, wherein the MIP actor uses quantile-sampling to find a best action α, given a current state of the large-scale stochastic system, and a current value approximation.

19. The computing platform of claim 17, wherein the critic approximator module is a deep neural network (DNN).

20. The computing platform of claim 17, wherein the critic approximator module is a rectified linear unit (RELUs) and is configured to learn a value function over a state-space of the environment.
